(19) United States
(12) Patent Application Publication
(10) Pub. No.: US 2026/0312821 A1
(43) Pub. Date: Oct. 8, 2026

(54) Method of Data Encryption with Recursive Semantic Fragmentation and MasterSeed Sealing

(71) Applicant: Joseph Anthony Citro, IV, Bennington, NE (US)

(72) Inventor: Joseph Anthony Citro, IV, Bennington, NE (US)

(21) Appl. No.: 19/638,798

(22) Filed: Apr. 3, 2026

Related U.S. Application Data
(60) Provisional application No. 63/784,042, filed on Apr. 5, 2025.

(51) Int. Cl. H04L 9/32; G06F 21/64; H04L 9/08

(52) U.S. Cl. CPC H04L 9/3239; G06F 21/64; H04L 9/0852; H04L 9/0869

(57) ABSTRACT

An encryption method and system for securing data through structure-aware semantic fragmentation. An input data stream is segmented into semantically meaningful fragments using a transformer-based neural network. Each fragment is bound by deterministic structural markers to create a tamper-evident chain. A Final Seed, derived from high-resolution timestamps and a hardware-anchored Personal Key, seeds a permutation function to shuffle the fragments. The system then applies a Quantum Lattice Transform to a subsequently derived MasterSeed, generating a post-quantum resilient symmetric key. This MasterSeed-derived key encrypts the permuted and bound fragments into a final secure payload. Decryption requires regenerating the exact permutation map and verifying the structural marker chain, ensuring data is protected against memory scraping and unauthorized access in decentralized environments.

### CROSS-REFERENCE TO RELATED APPLICATIONS

This application claims the benefit of U.S. Provisional Application No. 63/784,042, filed Apr. 5, 2025. The entire contents of the above-referenced application are hereby incorporated by reference.

### BACKGROUND OF THE INVENTION

Field of the Invention—The present invention relates generally to cryptography, data security, and decentralized data management. More specifically, the invention relates to a method of recursive semantic data fragmentation, deterministic structural binding, and dynamic key derivation tailored for memory-preserving artificial intelligence and advanced infrastructure systems.

Description of the Related Art—Standard cryptographic protocols (such as AES or RSA) are widely deployed to secure sensitive information. Traditional encryption methods secure data during storage and transmission, but once decrypted, the entire plaintext becomes exposed. These legacy architectures fundamentally rely on a monolithic, “all-or-nothing” decryption paradigm. When an authorized user or system application calls the decryption key, the ciphertext is transformed back into a singular, continuous string of unencrypted bytes residing in the system's active memory.

The Vulnerability in Modern Architectures—This binary approach presents a fundamental vulnerability, especially in decentralized, memory-preserving, or AI-aligned systems. Modern computational infrastructure, particularly those utilizing large language models (LLMs) or complex memory-aware AI frameworks, requires continuous, high-volume access to contextual data. Under the related art, securing this data means it must be fully decrypted into standard memory or Video RAM (VRAM) to be processed. This prolonged plaintext exposure leaves highly sensitive information vulnerable to memory scraping, deep-fake tampering, side-channel attacks, or unauthorized intra-tenant access on shared hardware.

The Need for a Solution—Therefore, there exists a critical need in the art for an encryption methodology that abandons the monolithic plaintext paradigm. What is required is a system capable of parsing data into semantically logical fragments, securing those fragments individually using dynamic, time-dependent cryptography, and obscuring the payload structure itself. Such a method would allow advanced AI and routing systems to process information securely without ever exposing the comprehensive plaintext payload to the host operating system or shared silicon environment.

### SUMMARY OF THE INVENTION

The present invention provides a method to mitigate the vulnerabilities of traditional encryption through a process of recursive data fragmentation, semantic-aware segmentation, and final-payload sealing using derived, time-dependent keys. Specifically, the invention describes an encryption method that segments input data into unique, semantically meaningful fragments. This enables chunking aligned with logical meaning rather than syntax alone. Following segmentation, the method assigns deterministic structural markers to each fragment and applies recursive encryption utilizing dynamically derived keys.

A core component of the system is the derivation of a unique Final Seed, which is generated from a combination of high-resolution timestamp-based components (designated as a Date-Chunk Seed) and a user-specific Personal Key (PK). In preferred embodiments, the Personal Key is derived from hardware-specific identifiers—such as the CPU processor serial number, network MAC address, and machine hostname—via a Physical Unclonable Function (PUF) simulation or hardware Trusted Execution Environment (TEE) query. This unique Final Seed governs both the fragment hashing process and the secure permutation of the segmented data. This secure reordering can be recursively reapplied across multiple passes, effectively increasing data entropy while strictly preserving contextual integrity.

To secure the overall architecture, the invention employs a final sealing step that encrypts the fully assembled payload. This step utilizes a distinct MasterSeed, derived in conjunction with a new timestamp and the original user-specific Personal Key. In preferred embodiments, this final sealing step applies a Quantum Lattice Transform to ensure payload-level obfuscation and strictly enforce recovery exclusivity.

### BRIEF DESCRIPTION OF DRAWINGS

FIG. 1 is a flowchart illustrating a method of data encryption with recursive semantic fragmentation and MasterSeed sealing, in accordance with one or more embodiments of the present invention.

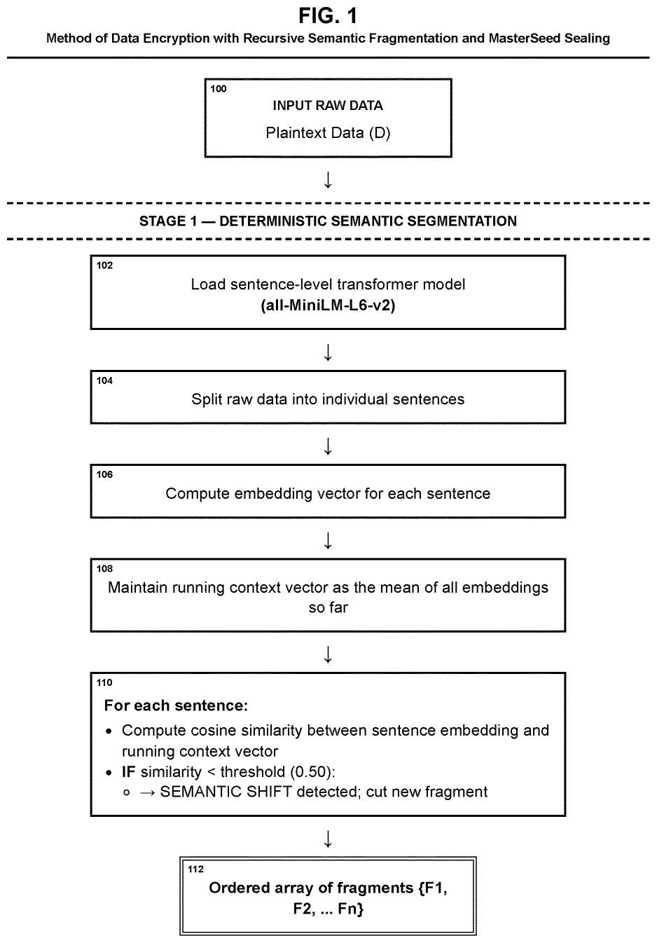

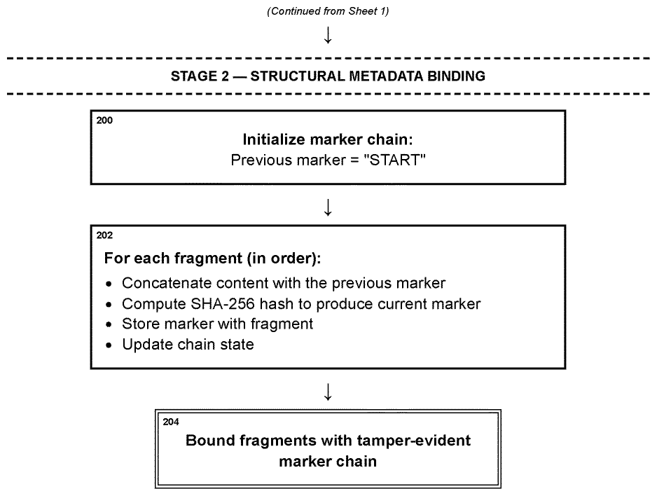

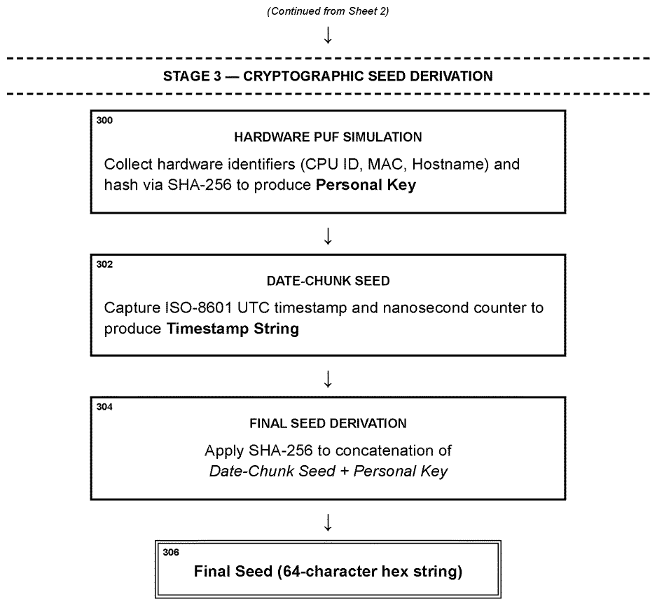

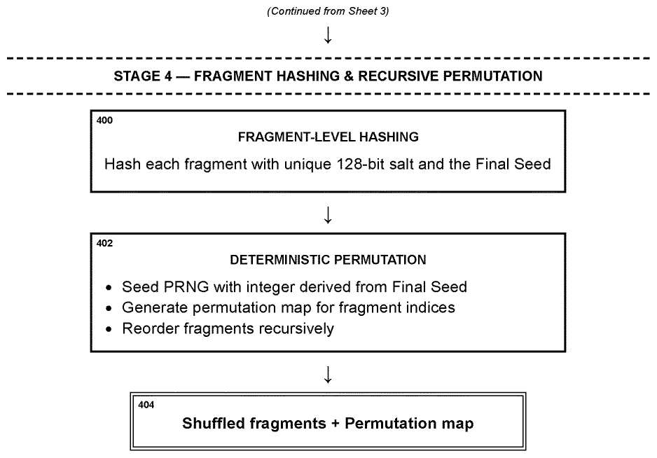

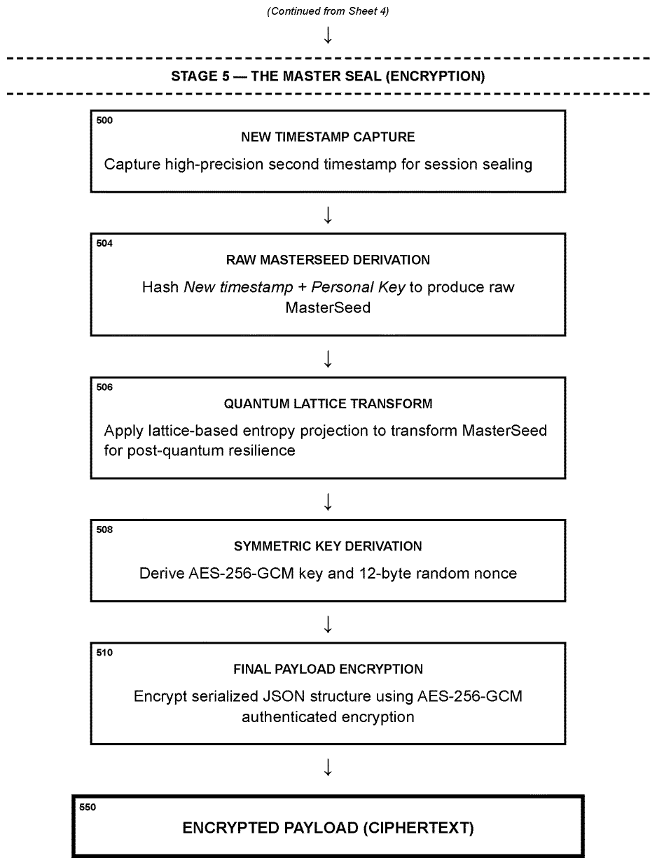

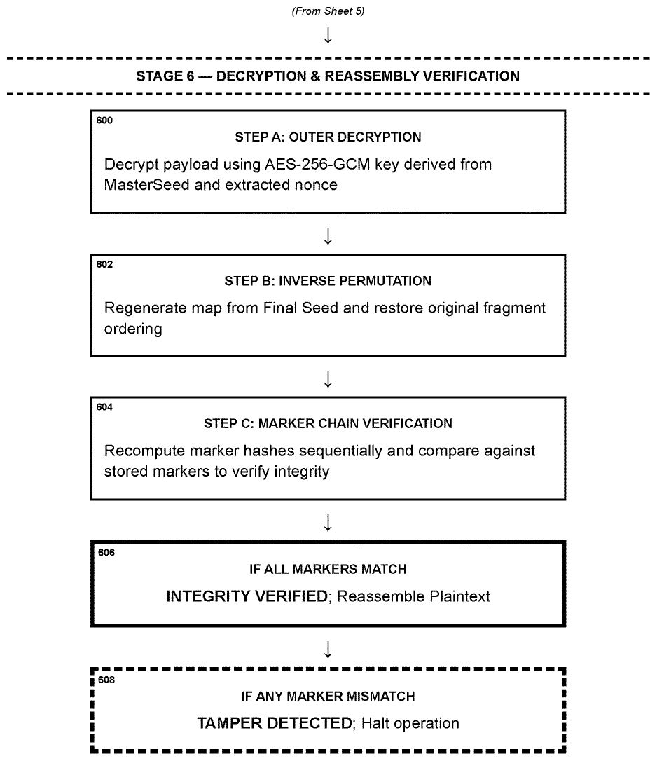

### DETAILED DESCRIPTION OF THE INVENTION

The present invention introduces a structure-aware encryption protocol. The process begins by inputting raw data 100. Unlike traditional methods that encrypt data as a singular continuous string, this system segments the input data into unique, semantically meaningful fragments.

The data is segmented into an ordered array of individual fragments 112, from the first through the last, using a defined segmentation function applied to the input data. This segmentation function may use static rules, such as line breaks or delimiters, or it may utilize an AI model. In preferred embodiments, the system first splits the raw data into individual sentences 104 and loads a sentence-level transformer model (such as all-MiniLM-L6-v2) 102 to generate embedding vectors for each sentence 106. A running context vector is maintained as the mean of all embeddings processed so far 108. For each sentence, the cosine similarity between each new sentence embedding and the running context vector is computed. When this similarity drops below a predefined threshold (e.g., 0.50), a “Semantic Shift” is triggered, indicating a semantic boundary 110. This enables chunking that is aligned with logical semantic boundaries rather than syntax alone, outputting an ordered array of fragments 112.

Once the data is fragmented, the system must ensure the sequence can be verifiably reassembled without exposing the plaintext. Each fragment is assigned a deterministic structural marker via a cryptographic hash of the current fragment's content concatenated with the preceding fragment's marker 202. The initial marker state is defined as the string literal “START” 200, and each subsequent marker is therefore a deterministic function of the current fragment and the marker immediately preceding it. This structural metadata creates a tamper-evident hash chain, outputting bound fragments 204. This allows for the reproducibility and verification of the data sequence without revealing the underlying data itself. Any modification to a single fragment invalidates all subsequent markers in the chain.

The system derives highly specific cryptographic keys. A Date-Chunk Seed is generated using high-resolution timestamp components 302, including the ISO-8601 UTC timestamp and a high-precision performance counter at nanosecond resolution. These components include the year, month, day, hour, minute, second, millisecond, microsecond, and nanosecond values captured at the moment of encryption.

A unique Final Seed is then computed by applying a cryptographic hash function to the concatenation of the Date-Chunk Seed and a user-specific Personal Key 304, yielding the Final Seed output 306. In preferred embodiments, the Personal Key is derived from an intrinsic hardware fingerprint using a Physical Unclonable Function (PUF) via a cryptographic attestation within a Trusted Execution Environment (TEE). In alternative embodiments, such as those utilizing a hardware PUF simulation, the Personal Key is derived from a hardware fingerprint comprising the concatenation of the CPU processor identifier, primary network MAC address, and machine hostname, which are hashed via SHA-256 to produce a deterministic, machine-unique key 300.

Each fragment is then individually hashed to secure its contents alongside its structural identity. The hash for each fragment is calculated by applying a cryptographic hash function to the concatenation of that fragment's structural marker, the fragment's content, the Final Seed, and a securely generated random salt of 128 bits 400. To increase data entropy while preserving contextual integrity, a deterministic permutation is generated using the Final Seed as a seed for a pseudo-random number generator 402. This permutation operates over the full set of fragment indices, from the first through the last. The fragments are reordered according to this permutation, and this reordering can be recursively reapplied across multiple passes, outputting shuffled fragments and the permutation map 404.

Following the recursive permutation, a final sealing step encrypts the assembled payload. This requires the derivation of a distinct MasterSeed, which is computed by concatenating a newly captured timestamp 500 and the retrieved user-specific Personal Key 502, and applying a SHA-256 hash to produce a raw MasterSeed 504. In certain embodiments, a Quantum Lattice Transform is applied to the raw MasterSeed to introduce additional cryptographic hardness based on lattice-inspired entropy shaping 506. The MasterSeed is used to derive a symmetric encryption key 508. In the reference implementation, the first 32 bytes of the MasterSeed are used directly as an AES-256-GCM symmetric key. The serialized, shuffled fragment structure is then encrypted using this symmetric key 510, producing an output of encrypted ciphertext and the MasterSeed 512. This yields the final encrypted payload 550 for secure storage or transit.

Decryption is performed by reversing the sealing, permutation, and binding stages in sequence. First, the outer payload is decrypted using the MasterSeed-derived symmetric key 600. Second, the Final Seed is used to regenerate the exact permutation map, and the inverse of that permutation is applied to restore the original fragment ordering 602. Third, the structural marker chain is recomputed 604 beginning from the initial marker, defined as the string literal “START,” and proceeding through each fragment in sequence. Each recomputed marker is compared against the corresponding stored marker to verify that no fragment has been modified, reordered, or removed. If all markers match, the system reports that integrity has been verified 606 and reassembles the fragments into the original plaintext. If any marker fails verification, the system reports that tampering has been detected 608, halting operation and identifying the exact point of corruption in the chain.

1. A method of data encryption and real-time semantic fragmentation, the method comprising:
a. Processing an input data stream through a transformer-based neural network having an attention mechanism;
b. Computing the cosine similarity of successive sentence embeddings against a running context vector to monitor for drops in semantic coherence;
c. Computing a deterministic segmentation of the data into a plurality of fragments triggered exactly when said cosine similarity exceeds a predefined variance threshold or when said cosine similarity drops below a predefined similarity threshold, thereby defining a semantic boundary;
d. Deriving a Final Seed from a combination of a high-precision Date-Chunk Seed and a user-specific Personal Key, wherein the Personal Key may be derived from hardware-specific identifiers via a Physical Unclonable Function or simulation thereof;
e. Computing fragment-level hashes for each of the plurality of fragments using a deterministic structural marker, a securely generated salt, and the Final Seed;
f. Applying a deterministic permutation function seeded by the Final Seed to reorder the plurality of fragments; and
g. Encrypting a final staged payload using a MasterSeed, wherein the MasterSeed is derived from a subsequent timestamp and the user-specific Personal Key.

2. The method of claim 1, further comprising:
a. Applying a secure permutation function recursively across the plurality of fragments to increase data entropy prior to final encryption.

3. The method of claim 1, wherein:
a. The MasterSeed is transformed via a Quantum Lattice Transform prior to encrypting the staged payload to provide post-quantum cryptographic resilience.

4. The method of claim 1, wherein:
a. Fragment decryption and reassembly is strictly restricted, requiring both a regenerated permutation map derived from the Final Seed and the valid MasterSeed, and further requiring verification of the structural marker chain from the initial marker through the final marker.

5. The method of claim 1, further comprising:
a. Utilizing a large language model or sentence-level transformer to directly align fragments with logical semantic boundaries, tracking the Euclidean or cosine distance between sequential vectors.

6. The method of claim 1, wherein:
a. The encryption process natively supports integration with context window compression frameworks and memory-aware AI models by utilizing the real-time semantic boundaries identified by the sentence-level transformer segmentation.

7. The method of claim 1, wherein:
a. The user-specific Personal Key is deterministically derived from a hardware fingerprint comprising a hash of the device CPU processor identifier, primary network interface MAC address, and machine hostname, thereby binding the encryption to a specific physical device without requiring external key storage.

8. The method of claim 1, further comprising:
a. Verifying data integrity upon decryption by recomputing the deterministic structural marker chain and comparing each recomputed marker against the stored markers, thereby detecting any tampering, reordering, or removal of fragments.

9. A system for data encryption and real-time semantic fragmentation, comprising:
a. A processor; and
b. a memory coupled to the processor, the memory storing instructions that, when executed by the processor, cause the system to perform the method of claim 1.

10. A non-transitory computer-readable storage medium storing instructions that, when executed by a processor, cause the processor to perform the method of claim 1.
